(19) United States
(12) Patent Application Publication
(10) Pub. No.: US 2023/0144417 A1
(43) Pub. Date: May 11, 2023

(54) COMMUNICATION CABLE AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuta YASUYOSHI, Mie (JP); Tatsuya SHIMADA, Mie (JP); Toru SHIMIZU, Mie (JP); Ryoma UEGAKI, Mie (JP); Kinji TAGUCHI, Mie (JP); Takaki ENDO, Mie (JP)

(21) Appl. No.: 17/915,249

(22) PCT Filed: Mar. 17, 2021
(86) PCT No.: PCT/JP2021/010770

§ 371 Date: Sep. 28, 2022

(30) Foreign Application Priority Data
Mar. 31, 2020 (JP) 2020-062149

(51) Int. Cl. H01B 7/295; H01B 11/00; C08L 23/12

(52) U.S. Cl. CPC H01B 7/295; H01B 11/002; C08L 23/12

(57) ABSTRACT

A communication cable 1 includes a conductor 11 for transmitting electric signals and an outer layer 15 that is disposed outside the conductor 11 and contains an organic polymer. The communication cable 1 has at least one of a first form in which the outer layer 15 contains a chloride-forming flame retardant capable of forming a chloride and a second form in which an inner layer 13 containing an organic polymer and a chloride-forming flame retardant capable of forming a chloride is further provided between the outer layer 15 and the conductor 11. The outer layer 15 contains a first organic polymer and a second organic polymer having a higher tensile modulus than the first organic polymer, and the overall organic polymer component constituting the outer layer 15 has a tensile modulus of at least 100 MPa.

### TECHNICAL FIELD

The present disclosure relates to a communication cable and a wire harness.

### BACKGROUND

There is an increasing demand for high-speed communication in the fields of automobiles and the like. Flame-retardancy is one of the important characteristics of cables, and a method for adding a flame retardant to an insulating covering for covering a conductor or a jacket (sheath) provided on the outer side of the insulating covering is often used as a method for imparting flame-retardancy to cables. In various flame retardants, metal hydroxides such as magnesium hydroxide exhibit high flame-retardancy while being inexpensive, and are widely used as flame retardants in communication cables. Patent Document 1 discloses a configuration of a communication cable that includes a twisted pair cable obtained by twisting a pair of insulated electric cables each including a conductor and an insulating covering that covers an outer circumferential surface of the conductor, and a sheath covering an outer circumferential surface of the twisted pair cable and made of an insulating material, magnesium hydroxide being added as a flame retardant to the insulating materials constituting the insulating covering and the sheath, for example.

### PRIOR ART DOCUMENT

### Patent Document

Patent Document 1: WO 2018/117204 A1

### SUMMARY OF THE INVENTION

### Problems to be Solved

Following the introduction of self-driving technology and improvements in the performance of various devices, a large number of communication cables are used in automobiles, and communication cables may also be disposed in high-temperature portions of automobiles where communication cables have not been disposed so far, such as in the vicinity of its engine. Communication cables are required to be able to perform more stable and accurate communication even in such a high-temperature environment. However, if a communication cable is arranged in contact with another cable having an insulating covering made of a material containing a plasticizer, the plasticizer may be transferred from the other cable to the communication cable in a high-temperature environment. Further, if a resin material constituting the other cable is polyvinyl chloride or the like and contains chlorine atoms, the chlorine atoms may also be transferred to the jacket or the insulating covering of the communication cable together with the plasticizer.

If a communication cable contains a flame retardant such as a metal hydroxide, the flame retardant does not greatly influence the communication characteristics of the communication cable. Also, the size and the material composition of each constituent member of the communication cable are designed such that desired communication characteristics can be obtained in a state where the communication cable contains the flame retardant. However, following the transfer of the communication cable, if chlorine atoms are transferred to the jacket or the insulating covering that is part of the communication cable and the chlorine atoms undergo a chemical reaction with the flame retardant in a high-temperature environment, the communication characteristics of the communication cable may be influenced and the designed communication characteristics may not be obtained. If the flame retardant forms chloride, for example, the chloride may change the dielectric properties of the jacket and the insulating covering of the communication cable and change the communication characteristics of the communication cable.

In view of the above-described issues, the present invention aims to provide a communication cable that can reduce the influence of the transfer of chlorine atoms accompanying the transfer of a plasticizer from adjacent members even when the constituent material contains a flame retardant capable of forming chloride, and to provide a wire harness that includes such a communication cable.

### Means to Solve the Problem

A communication cable according to this disclosure includes a conductor for transmitting electric signals and an outer layer that is disposed outside the conductor and contains an organic polymer. The communication cable has at least one of a first form in which the outer layer contains a chloride-forming flame retardant capable of forming a chloride and a second form in which an inner layer, which contains an organic polymer and a chloride-forming flame retardant capable of forming a chloride, is further provided between the outer layer and the conductor. The outer layer contains a first organic polymer and a second organic polymer having a higher tensile modulus than the first organic polymer, and the overall organic polymer component constituting the outer layer has a tensile modulus of at least 100 MPa.

A wire harness according to this disclosure includes the communication cable and a chlorine-containing member that contains a component having chlorine atoms and a plasticizer, and the chloride-containing member is disposed in contact with at least a portion of the outer layer of the communication cable.

### Effect of the Invention

The communication cable according to this disclosure can reduce the influence of the transfer of chlorine atoms accompanying the transfer of a plasticizer from adjacent members even when the constituent material of the communication cable contains a flame retardant capable of forming a chloride, and the wire harness according to this disclosure includes such a communication cable.

### BRIEF DESCRIPTION OF THE DRAWINGS

FIG. 1 is a cross-sectional view showing a configuration of a wire harness that includes a communication cable according to one embodiment of this disclosure.

FIG. 2A is a diagram showing a change in characteristic impedance when a communication cable is heated. FIG. 2B is a diagram showing changes in the amount of magnesium chloride produced when a communication cable is heated.

FIG. 3 is a diagram showing the relationship between the tensile moduli and the plasticizer absorption ratios of materials.

FIG. 4 is a diagram showing the relationship between the thickness of an insulating covering and the characteristic impedance when both magnesium hydroxide and a brominated flame retardant are used as flame retardants, and when only magnesium hydroxide is used as a flame retardant.

### DETAILED DESCRIPTION TO EXECUTE THE INVENTION

### Description of Embodiments of the Present Disclosure

First, embodiments of this disclosure will be described below.

A communication cable according to this disclosure includes a conductor for transmitting electric signals and an outer layer that is disposed outside the conductor and contains an organic polymer. The communication cable has at least one of a first form in which the outer layer contains a chloride-forming flame retardant capable of forming a chloride and a second form in which an inner layer, which contains an organic polymer and a chloride-forming flame retardant capable of forming a chloride, is further provided between the outer layer and the conductor. The outer layer contains a first organic polymer and a second organic polymer having a higher tensile modulus than the first organic polymer, and the overall organic polymer component constituting the outer layer has a tensile modulus of at least 100 MPa.

In the communication cable, the overall organic polymer component constituting the outer layer disposed outside the conductor has a tensile modulus of at least 100 MPa, and contains two types of organic polymers having different tensile moduli. The higher the tensile modulus of the organic polymers constituting the outer layer is, the harder and the more dense the structure of the outer layer is. Thus, the plasticizer tends not to be transferred from adjacent members to the outer layer. Further, because two types of organic polymers are mixed in the outer layer, the plasticizer is less likely to be transferred thereto than a plasticizer in which only one type of organic polymer is used. If a plasticizer is less likely to be transferred, then, chlorine atoms are also less likely to be transferred accompanying the transfer of the plasticizer. As a result, even when the outer layer of a communication cable contains a flame retardant capable of forming a chloride (the first form) or even when the inner layer that is present inward of the outer layer contains such a flame retardant (the second form), it is possible to suppress the chloride formation through a reaction between the flame retardant and chlorine atoms entering from the outside. As a result, it is possible to reduce influences on communication characteristics due to the transfer of chlorine atoms and the subsequent chloride formation, such as changes in dielectric properties.

Here, the overall organic polymer component constituting the outer layer preferably has a tensile modulus of at least 300 MPa. As a result, it is possible to particularly effectively suppress the transfer of a plasticizer and the subsequent transfer of chlorine atoms.

Here, the overall organic polymer component constituting the outer layer preferably has a tensile modulus of not more than 500 MPa. Thus, it is possible to suppress a decrease in the flexibility of the communication cable due to the structure of the outer layer being hardened.

A chloride formed by the chloride-forming flame retardant is preferably deliquescent chloride. If the chloride that is formed by a flame retardant following the transfer of chlorine atoms in the outer layer and the inner layer is a deliquescent chloride, the chloride becomes hydrated by the moisture in the air, and water droplets and a water vapor atmosphere may be formed in the outer layer or the inner layer and its surface, and in the space surrounded by these layers. As a result, the dielectric properties of the outer layer or the inner layer greatly change, and the communication characteristics of the communication cable are likely to be influenced. However, because the organic polymer component constituting the outer layer has at least a predetermined tensile modulus and contains two types of organic polymers, the transfer of the plasticizer and the subsequent transfer of chlorine atoms are suppressed. As a result, deliquescent chloride tends not to be formed, and the influence of the formation of hydrates on communication characteristics can be effectively reduced.

The chloride-forming flame retardant preferably contains magnesium hydroxide. Magnesium hydroxide exhibits high flame-retardancy while being inexpensive, and is often used as a flame retardant to be added to cables. However, it is known that magnesium hydroxide forms deliquescent chloride. However, as described above, even when the outer layer and the inner layer of the communication cable contain magnesium hydroxide, it is possible to greatly reduce the influence of the formation of deliquescent chloride on communication characteristics because the organic polymer component constituting the outer layer has a predetermined tensile modulus and contains two or more types of organic polymers, suppressing the transfer of chlorine atoms accompanying the transfer of the plasticizer.

The first organic polymer and the second organic polymer may be each independently a polyolefin or an olefin-based elastomer. Polyolefins and olefin-based elastomers are inexpensive and have a low permittivity, for example, and thus can be favorably used as insulating materials for constituting communication cables. The structure of a material through which a plasticizer does not easily permeate can be formed by mixing multiple types of polyolefins and olefin-based elastomers. Also, polyolefins and olefin-based elastomers with various tensile moduli are known, and an outer layer having a desired tensile modulus can be easily formed by selecting specific types of materials to be mixed and a mixing ratio of materials.

The communication cable has both the first form and the second form, the outer layer preferably contains the chloride-forming flame retardant, and the inner layer containing the chloride-forming flame retardant is preferably provided between the outer layer and the conductor. As a result, it is possible to ensure the flame-retardancy in both the outer layer and the inner layer resulting from these layers containing the flame retardant. Because the organic polymer component constituting the outer layer has a predetermined tensile modulus and contains two or more types of organic polymers, it is possible to suppress permeation of the plasticizer, and thus, to effectively suppress the transfer of chlorine atoms accompanying the transfer of the plasticizer and the chloride formation due to the added flame retardant, not only in the outer layer but also in the inner layer that is present inward of the outer layer. Because the distance to the conductor is shorter in the inner layer, if dielectric properties change due to the chloride formation or the like, the influence of the change on communication characteristics tends to be greater than that in the outer layer.

The communication cable may have a pair of insulated electric wires as signal wires each provided with an insulating covering as the inner layer on an outer circumferential surface of the conductor, and a jacket may cover an outer circumferential surface of the signal wire as the outer layer. The communication cables having this type of structure are used to transmit differential signals, and communication characteristics tend to be influenced by the chemical compositions of the insulating coverings and the jacket due to changes in dielectric properties. However, the influence of the transfer of chlorine atoms to the jacket or the insulating coverings on communication characteristics can be effectively reduced by making it possible to suppress the transfer of the plasticizer and the subsequent transfer of chlorine atoms in the jacket.

The outer layer in the first form and the inner layer in the second form may contain the chloride-forming flame retardant and a brominated flame retardant. In order to obtain sufficient flame-retardancy using a flame retardant capable of forming chloride, such as magnesium hydroxide, a comparatively large amount of the flame retardant needs to be added to an organic polymer material. However, if a large amount of fillers such as a flame retardant is added to the organic polymer material, heat resistance, that is, durability in high-temperature environments, may decrease. However, the amount of chloride-forming flame retardant added can be reduced using a brominated flame retardant that exhibits a high flame retarding effect. As a result, it is possible to increase the heat resistance of the communication cable, and due to the effect to suppress the chloride formation at high temperatures as well, it is possible to favorably use the communication cable even in high-temperature environments. Also, the chloride formation accompanying the transfer of the plasticizer and chlorine atoms can be slowed by using magnesium hydroxide and a brominated flame retardant in combination.

In this case, the outer layer in the first form and the inner layer in the second form preferably contain magnesium hydroxide serving as the chloride-forming flame retardant in an amount of 30 parts by mass to 70 parts by mass, and the brominated flame retardant in an amount of 20 parts by mass to 60 parts by mass with respect to 100 parts by mass of the organic polymer component. As a result, high flame-retardancy and high heat resistance can be achieved by adding magnesium hydroxide and the brominated flame retardant to the outer layer and/or the inner layer in a well-balanced manner.

If the communication cable has a pair of insulated electric wires as signal wires each provided with an insulating covering as the inner layer on an outer circumferential surface of the conductor, and the jacket serving as the outer layer covers the outer circumferential surface of the signal wire, then the communication cable may has at least the second form, the insulating covering may contain the brominated flame retardant as well as magnesium hydroxide serving as the chloride-forming flame retardant, the thickness of the insulating covering may be smaller than 0.18 mm, and the characteristic impedance of the communication cable may be 100±10Ω. When the insulating covering contains a brominated flame retardant, the permittivity of the insulating covering material is lower than that when the insulating covering contains only magnesium hydroxide as a flame retardant, and the characteristic impedance of the communication cable decreases. However, a characteristic impedance of 100±10Ω, which is required of Ethernet communication etc., can be easily ensured by reducing the thickness of the insulating covering to less than 0.18 mm.

A wire harness according to this disclosure includes the communication cable and a chlorine-containing member made of a polymer composition that contains a component having chlorine atoms and a plasticizer, and the chloride-containing member is disposed in contact with at least a portion of the outer layer of the communication cable.

In the wire harness, the chlorine-containing member containing the component having chlorine atoms together with the plasticizer is disposed in contact with the outer layer of the communication cable. Because the organic polymer component constituting the outer layer of the communication cable has an elastic modulus of at least 100 MPa and contains two types of organic polymers, the transfer of the plasticizer and the subsequent transfer of the chlorine atoms can be suppressed. Thereby, even when the outer layer or the inner layer of the communication cable contains a chloride-forming flame retardant, the transfer of chlorine atoms from the chlorine-containing member can be prevented from influencing the communication characteristics of the communication cable.

Here, the chlorine-containing member is preferably a coating member constituting a covered electric wire other than the communication cable. As a result, even when a wire harness is constructed by bundling a communication cable together with a general-purpose covered electric wire obtained by covering a conductor with a material obtained by adding a plasticizer to an organic polymer containing chlorine, such as a polyvinyl chloride-based resin and used in a high-temperature environment, it is possible to maintain the communication characteristics of the communication cable at a high level.

### Details of Embodiments of the Present Disclosure

Hereinafter, a communication cable according to one embodiment of this disclosure will be described in detail with reference to the drawings. The values of the properties of various materials, such as tensile moduli, are obtained through measurement in an atmosphere at room temperature in this specification, unless otherwise stated. Also, with regard to a material composition, when a given component is the main component, the amount of this component in the total mass of the material is at least 50 mass % in this specification. Examples of organic polymers include polymers with a relatively low degree of polymerization, such as oligomers. In this specification, with regard to the properties of a composition, such as tensile moduli, the phrase “the overall organic polymer component” refers to a state in which only the organic polymers contained in the composition are mixed, and does not refer to the entire composition containing components other than the organic polymer components, such as a flame retardant.

Overall Configuration of Communication Cable and Wire Harness

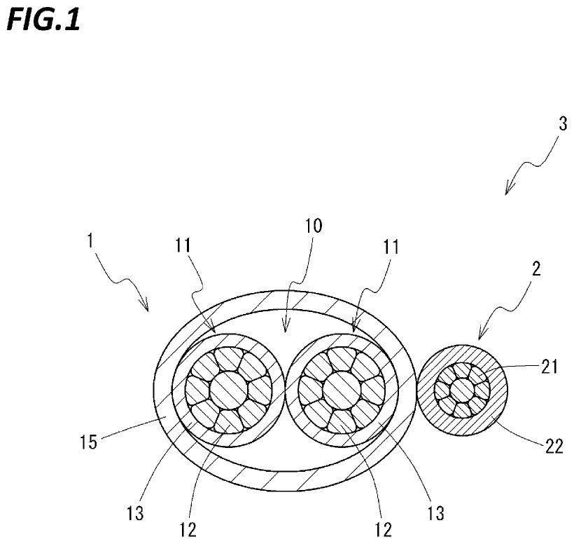

FIG. 1 shows a cross-sectional view of a wire harness 3 according to one embodiment of this disclosure, the wire harness 3 being cut perpendicularly to its axial direction. The wire harness 3 includes a communication cable 1 according to one embodiment of this disclosure and a parallel cable 2. The wire harness 3 may also include other wires.

The communication cable 1 has a signal wire 10. The signal wire 10 includes a pair of insulated electric wires 11 and 11. The communication cable 1 further includes, as the outer layer, a jacket 15 covering the outer circumferential surface of the signal wire 10.

In the signal wire 10, a pair of insulated electric wires 11 and 11 transmit differential signals. Although the pair of insulated electric wires 11 and 11 in the signal wire 10 may be arranged in parallel with each other with their axial directions aligned with each other, from the viewpoint of noise reduction etc., the pair of insulated electric wires 11 and 11 is preferably constituted as a twisted wire pair. The insulated electric wires 11 constituting the signal wire 10 each includes a conductor 12 and an insulating covering 13 covering the outer circumferential surface of the conductor 12. If the signal wire 10 is configured as a twisted wire pair, the communication frequency in the communication cable 1 is preferably in a range of about 1 MHz to 1 GHz.

Although various metallic materials can be used as the material constituting the conductor 12, it is preferable to use a copper alloy from the viewpoint of reducing transmission loss of the signals transmitted through the signal wire 10 using high electrical conductivity and maintaining sufficient strength even when the diameter of the signal wire 10 is reduced, for example. Although the conductor 12 is constituted by a single wire, the conductor 12 is preferably constituted by a twisted wire obtained by twisting a plurality of wires (e.g., seven wires), from the viewpoint of increasing flexibility when the conductor 12 is bent, for example. In this case, the wires are twisted and subjected to compression molding to obtain a compressed twisted wire. If the conductor 12 is constituted by a twisted wire, the twisted wire may be constituted by the same wires or two or more types of wires. The insulating covering 13 serves as the inner layer in the communication cable 1. Although the constituent material of the insulating covering 13 will be described later in detail, the constituent material contains an organic polymer and a chloride-forming flame retardant (a flame retardant capable of forming chloride through reaction with chlorine-containing molecules).

Although there is no particular limitation to the diameter of the conductor 12 and the thickness of the insulating covering 13, from the viewpoint of reducing the diameter of the insulated electric wire 11, the cross-sectional area of the conductor is preferably less than 0.22 mm², and particularly preferably not more than 0.15 mm². Also, the thickness of the insulating covering 13 is preferably set to not more than 0.30 mm, and particularly set to not more than 0.20 mm. If a conductor having such a cross-sectional area and a covering having such a thickness are adopted, the outer diameter of the insulated electric wires 11 can be set to not more than 1.0 mm, and not more than 0.90 mm. Also, when a conductor having such a cross-sectional area and a covering having such a thickness are adopted, the characteristic impedance of the communication cable 1 can be easily kept in a range of 100±10Ω, which is required of Ethernet communication. The twist pitch of a twisted wire pair may range from at least 10 mm to not more than 30 mm, for example.

The jacket 15 is a member that functions to protect the signal wire 10 and maintains the twisted structure in the communication cable 1, for example, and suppresses the transfer of the plasticizer and chlorine atoms to the inside of the communication cable 1 as will be described later. The jacket 15 may collectively cover the outer circumferential surface of the bundle of the multiple signal wires 10, or preferably continuously covers the outer circumferential surface of only one signal wire 10. Although other layers such as a shield layer may be interposed between the jacket 15 and the signal wire 10, it is mainly presumed here that the insulating covering 13 constituting the signal wire 10 and the jacket 15 are in direct contact with each other without other layers interposed therebetween. On the other hand, in the communication cable 1, no other layers are provided outside the jacket 15, and the jacket 15 is in direct contact with the parallel cable 2. Alternatively, a layer made of a material through which the plasticizer and chlorine-containing molecules can permeate may also be interposed between the jacket 15 and the parallel cable 2. As shown in FIG. 1, the jacket 15 may have a hollow structure having a space between the jacket 15 and the signal wire 10, or may have a solid structure in which the inside of the jacket 15 is filled with the constituent material of the jacket 15 to just outside the signal wire 10.

Although the constituent material of the jacket 15 will be described in detail later, it contains an organic polymer and a chloride-forming flame retardant. The constituent material contains two or more types of organic polymers having different tensile moduli, and a constituent material having a predetermined tensile modulus overall is used. Because the organic polymer component has such a structure, the jacket 15 suppresses the transfer of the plasticizer and chlorine atoms from outside. Although there is no particular limitation on the thickness of the jacket 15, from the viewpoint of sufficiently exhibiting the above functions, the thickness of the jacket 15 is preferably at least 0.2 mm, or more preferably at least 0.3 mm. On the other hand, from the viewpoint of avoiding an excessive increase in the diameter of the communication cable 1, the thickness of the jacket 15 may be set to not more than 1.2 mm, or not more than 1.0 mm

The parallel cable 2 constituting the wire harness 3 together with the communication cable 1 has a conductor 21 and a chlorine-containing coating layer 22 as an insulating covering that covers the outer circumferential surface of the conductor 21. There is no particular limitation on the specific type and the specific shape of the parallel cable 2, and another layer may also be interposed between the conductor 21 and the chlorine-containing coating layer 22, for example. However, no other layer is provided on the outer circumferential surface of the chlorine-containing coating layer 22, and the chlorine-containing coating layer 22 is in direct contact with the jacket 15 of the communication cable 1 in the wire harness 3. Alternatively, a layer made of a material through which the plasticizer and chlorine-containing molecules can permeate may be interposed between the chlorine-containing coating layer 22 and the communication cable 1.

Similarly to the conductors 12 of the communication cable 1, the conductor 21 of the parallel cable 2 is also made of a metallic material such as a copper alloy. Although the constituent material of the chlorine-containing coating layer 22 will be described later in detail, the constituent material is configured as a polymer composition that contains a component having chlorine atoms and a plasticizer.

As described above, the wire harness 3 according to this embodiment includes the communication cable 1 and the parallel cable 2. The communication cable 1 has the jacket 15 serving as the outer layer on its outermost portion, and has the insulating coverings 13 serving as the inner layers between the jacket 15 and the conductors 12 for transmitting electric signals. The configuration of the communication cable having the inner layer in addition to the outer layer is not limited to the above configuration in which the jacket 15 is provided on the outer circumferential surface of the signal wire 10 that includes the plurality of insulated electric wires 11, and a configuration may also be adopted in which the outer layer is provided on the outer circumferential surface of one insulated electric wire provided with the insulating covering serving as the inner layer, such as a coaxial cable, for example. Further, the communication cable need not have the inner layer as long as the outer layer is disposed outside the conductors, and the insulating covering serving as the outer layer may also be disposed directly on the outer circumferential surface of the conductors, for example.

Further, the chloride-forming flame retardant is added to both the jacket 15 serving as outer layer and the insulating covering 13 serving as the inner layer in the above-described embodiment. However, if the communication cable has the inner layer in addition to the outer layer, the chloride-forming flame retardant need not be added to both the outer layer and the inner layer, and need only be added to at least one of the outer layer and the inner layer. That is, the communication cable 1 need only have at least one of a first form in which the outer layer contains a chloride-forming flame retardant and a second form in which the inner layer containing a chloride-forming flame retardant is further provided between the outer layer and the conductors. However, as in the above-described embodiment, the communication cable 1 preferably has both the first form and the second form, and a configuration in which the outer layer and the inner layer contain a chloride-forming flame retardant is preferable in light of enhancing the effect to reduce the influence of the chloride formation on transmission characteristics, which will be described later. The outer layer and the inner layer may each have a plurality of layers. The jacket 15 and the insulating covering 13 can each have a plurality of layers, for example, and all of the layers that are laminated as the jacket 15 or the insulating covering 13 may form the outer layer or the inner layer, or the outer layer and the inner layer may be laminated on each other as a layer constituting either the jacket 15 or the insulating covering 13.

Although the communication cable 1 according to an embodiment of this disclosure is in contact with the parallel cable 2 having the chlorine-containing coating layer 22 and is a constituent part of the wire harness 3 in the above-described embodiment, the communication cable 1 need not be a constituent part of such a wire harness 3. The effect to suppress the transfer of the plasticizer and chlorine atoms from the chlorine-containing member can be obtained by bringing at least a portion of the outer layer (jacket 15) into contact with a chlorine-containing member made of a polymer composition that contains a component having chlorine atoms and a plasticizer and disposing the communication cable. Examples of chlorine-containing members include insulating coverings such as the above chlorine-containing coating layer 22, outer cover members such as tape for bundling multiple cables including the communication cable 1, and protective members such as a protective sheet.

Material Composition of Coating Layers

As described above, the wire harness 3 according to this embodiment includes three types of coating layers made of polymer compositions, namely, the outer layer (jacket 15) and the inner layer (insulating covering 13) of the communication cable 1, and the chlorine-containing coating layer 22 of the parallel cable 2. The following describes the constituent materials of the layers.

(1) Outer Layer of Communication Cable

As described above, the jacket 15 serving as the outer layer of the communication cable 1 contains an organic polymer and a chloride-forming flame retardant.

(1-1) Organic Polymer Component

At least two types, namely, a first organic polymer and a second organic polymer, are contained as the organic polymer component constituting the jacket 15, and the second organic polymer has a higher tensile modulus than the first organic polymer. Also, the overall organic polymer component has a tensile modulus of at least 100 MPa (the tensile modulus may be simply referred to as elastic modulus hereinafter). The tensile modulus of a polymer material can be evaluated through tensile testing in conformity to JIS K 7161-1: 2014, for example. Note that usually there is no large difference between tensile modulus and flexural modulus in the organic polymer component, and when the elastic moduli of the first organic polymer and the second organic polymer are compared with each other, flexural modulus may also be used as appropriate, instead of tensile modulus.

When the overall organic polymer component has an elastic modulus of at least 100 MPa, as will be described later, the jacket 15 suppresses the transfer of the plasticizer and chlorine atoms. If the elastic modulus of the overall organic polymer component is at least 200 MPa, at least 300 MPa, or at least 350 MPa, the transfer suppression effect is further enhanced. Although there is no particular limitation to the upper limit of the elastic modulus of the overall organic polymer component, from the viewpoint of preventing the structure from becoming excessively hard and ensuring sufficient flexibility for the cable, for example, the upper limit of the elastic modulus of the overall organic polymer component is preferably not more than 500 MPa, or more preferably not more than 450 MPa.

Although there is no particular limitation to the type of organic polymers contained in the jacket 15, as a preferable configuration, a copolymer that includes an olefin unit such as a polyolefin (e.g., polypropylene) or an olefin-based elastomer is the main component in the organic polymer component constituting the jacket 15, for example. Because these olefin-based polymers have a low permittivity, are inexpensive, and provide good communication characteristics, they can be favorably used as the constituent material of the jacket 15. The organic polymer component constituting the jacket 15 may also contain an elastomer other than the olefin-based polymers, such as SEBS, in addition to an olefin-based polymer, as appropriate.

Although the first organic polymer and the second organic polymer that are contained in the jacket 15 as the organic polymer components, or the other organic polymers, may be the same type or different types, from the viewpoint of compatibility and the like, at least the first organic polymer and the second organic polymer are preferably the same type. Most preferably, both the first organic polymer and the second organic polymer are olefin-based polymers. Organic polymers can have various elastic moduli even when they are the same type, depending on the type or the degree of polymerization of monomer units, the sequence of monomer units, and the like. As a preferable configuration, the first organic polymer having a lower elastic modulus is an olefin-based elastomer, and the second organic polymer having a higher elastic modulus is a polyolefin, for example. Alternatively, a configuration may be adopted in which both the first organic polymer and the second organic polymer are polyolefins or olefin-based elastomers, and they have different elastic moduli.

There is no particular limitation to the specific elastic moduli of the first organic polymer and the second organic polymer. However, it is preferable that the elastic modulus of the first organic polymer is lower than a desired elastic modulus of the overall organic polymer component, the elastic modulus of the second organic polymer is higher than the desired elastic modulus of the overall organic polymer component, and the first organic polymer and the second organic polymer are mixed together. As a result, the overall organic polymer component containing the mixed organic polymers tends to have a desired elastic modulus. From the viewpoint of increasing the degree of freedom to adjust the elastic modulus of the overall polymer component, and from the viewpoint of enhancing the effect of suppressing the transfer of the plasticizer and chlorine atoms, the elastic modulus of the second organic polymer is preferably at least three times, at least five times, or at least ten times the elastic modulus of the first organic polymer. Further, the elastic modulus of the first organic polymer is preferably at least 100 MPa and not more than 500 MPa, and the elastic modulus of the second organic polymer is preferably at least 1000 MPa and not more than 3000 MPa.

There is no particular limitation to the ratio of the first organic polymer and the second organic polymer mixed (the mixing ratio), and this mixing ratio need only be set such that the overall organic polymer component has a desired elastic modulus. As a preferable mixing ratio, the mass ratio of the second organic polymer to the first organic polymer ([second organic polymer]/[first organic polymer]) is at least 1/9 and not more than 9/1, or not more than 5/5, for example. Although there is no particular limitation to the states of the first organic polymer and the second organic polymer in the material structure of the jacket 15, it is preferable that the first organic polymer and the second organic polymer are highly uniformly mixed with each other. In particular, it is preferable that the first organic polymer and the second organic polymer each form minute regions, and these regions are mixed with each other. An example of such a mixed state is a state in which a polymer alloy is formed. The organic polymer component may be crosslinked or foamed in the jacket 15.

(1-2) Flame Retardant

As described above, the constituent material of the jacket 15 contains the chloride-forming flame retardant. “Chloride-forming flame retardant” refers to a flame retardant capable of forming chloride through a reaction with chlorine-containing molecules. There is no particular limitation to a specific type of chloride-forming flame retardant, and examples thereof include inorganic flame retardants in which metal elements and inorganic elements other than chlorine are bonded. When these inorganic flame retardants react with chlorine-containing molecules, metal chlorides can be formed. Examples of typical inorganic flame retardants include flame retardants containing a metal hydroxide such as magnesium hydroxide, aluminum hydroxide, or zirconium hydroxide. In particular, magnesium hydroxide is often used in coating members for cables as an inexpensive flame retardant, and can also be favorably used in this embodiment. The chloride-forming flame retardant may be used alone or in combination of two or more.

If an inorganic flame retardant such as a metal hydroxide is used as a chloride-forming flame retardant, the particle size of the chloride-forming flame retardant is preferably at least 0.5 μm from the viewpoint of avoiding aggregation, and not more than 5 μm from the viewpoint of increasing dispersibility in the organic polymer component. In order to improve dispersibility, surface treatment may also be performed on the chloride-forming flame retardant using a dispersing agent such as a silane coupling agent or wax. Also, from the viewpoint of exhibiting sufficient flame-retardancy, for example, the content of the chloride-forming flame retardant in the constituent material of the jacket 15 is preferably at least 30 parts by mass with respect to 100 parts by mass of the organic polymer component. On the other hand, from the viewpoint of reducing the influence on mechanical properties of the jacket 15 and the communication characteristics of the communication cable 1, for example, the content of the chloride-forming flame retardant is preferably not more than 150 parts by mass. Note that the content of the chloride-forming flame retardant mentioned here can be favorably applied in particular when the brominated flame retardant described below is not used in combination.

The constituent material of the jacket 15 may also contain an additive component other than the chloride-forming flame retardant as appropriate. Examples of additive components other than the chloride-forming flame retardant include other types of flame retardants that substantially do not form chloride. Examples of flame retardants that substantially do not form chloride include brominated flame retardants.

Specific examples of the brominated flame retardants include brominated flame retardants having a phthalimide structure, such as ethylene bis(tetrabromophthalimide) and ethylene bis(tribromophthalimide), ethylene bis(pentabromophenyl), tetrabromobisphenol A (TBBA), hexabromocyclododecane (HBCD), TBBA-carbonateoligomer, TBBA-epoxy.oligomer, brominated polystyrene, TBBA-bis(dibromopropyl ether), poly(dibromopropyl ether), and hexabromobenzene (HBB). These brominated flame retardant may be used alone or in combination. From the viewpoint of a high melting point and excellent heat resistance, it is preferably to use at least one or more selected from phthalimide-based flame retardants, ethylene bispentabromophenyl, and derivatives thereof.

Chloride-forming flame retardants such as magnesium hydroxide can be used at a relatively low cost, and manufacturing costs incurred to produce the entire cable can be reduced by using these chloride-forming flame retardants as flame retardants to be added to the organic polymer component. However, a comparatively large amount of these chloride-forming flame retardants need to be added in order to achieve sufficient flame-retardancy. If a large amount of a solid particulate filler such as a chloride-forming flame retardant is added to the organic polymer component, the total area of the interface between the organic polymer component and the filler increases, and the entry of oxygen through the interface facilitates the oxidation degradation of the organic polymer component in a high temperature condition. That is, the heat resistance of the constituent material of the jacket 15 decreases. In view of this, by adding a brominated flame retardant, which is a relatively expensive flame retardant but has higher flame-retardancy than a chloride-forming flame retardant, as a part of the flame retardant, it is possible to reduce the amount of the chloride-forming flame retardant used and achieve high flame-retardancy and high heat resistance.

Also, the formation of magnesium chloride accompanying the transfer of the plasticizer and chlorine atoms can be more effectively suppressed by using magnesium hydroxide and the brominated flame retardant in combination as flame retardants. If only magnesium hydroxide is used as a flame retardant, magnesium hydroxide particles dispersed in the polymer component tends to lead to secondary aggregation. If the plasticizer and chlorine atoms enter this aggregate, the entire aggregate may react with the chlorine atoms at once, forming chlorides. On the other hand, if a part of the flame retardant is replaced with a brominated flame retardant, the dispersibility of magnesium hydroxide is improved, and magnesium hydroxide tends not to lead to secondary aggregation. As a result, a large amount of magnesium hydroxide is less likely to react with chlorine atoms at once to form chloride. Also, even when magnesium hydroxide aggregates together with a brominated flame retardant, the brominated flame retardant does not react with chlorine atoms. Therefore, it is less likely that a large amount of magnesium hydroxide will react with chlorine atoms at once. It is possible to obtain the effect of slowing the production of magnesium chloride by using magnesium hydroxide and a brominated flame retardant in combination as flame retardants in this manner.

If magnesium hydroxide and a brominated flame retardant are used in combination as flame retardants, from the viewpoint of achieving flame-retardancy and heat resistance while sufficiently reducing costs, from the viewpoint of enhancing the effect of slowing chloride formation, and from the viewpoint of reducing the influence on the mechanical properties of the organic polymer component, for example, the magnesium hydroxide content is preferably at least 30 parts by mass, and more preferably at least 40 parts by mass with respect to 100 parts by mass of the organic polymer component. Also, the magnesium hydroxide content is preferably not more than 70 parts by mass, and more preferably not more than 50 parts by mass. On the other hand, the brominated flame retardant content is preferably at least 20 parts by mass, and more preferably at least 30 parts by mass with respect to 100 parts by mass of the organic polymer component. Also, the brominated flame retardant content is preferably not more than 60 parts by mass, and more preferably not more than 40 parts by mass. The ratio of the brominated flame retardant content to the magnesium hydroxide content is preferably a mass ratio ([brominated flame retardant]/[magnesium hydroxide]) of at least 1/3 and more preferably a mass ratio of at least 1/2, and preferably not more than 1/1.

The constituent material of the jacket 15 may contain a flame retardant auxiliary agent such as antimony trioxide, in addition to the brominated flame retardant as appropriate. The brominated flame retardant content is preferably about half of the mass of the brominated flame retardant, and may be at least 10 parts by mass and not more than 30 parts by mass with respect to 100 parts by mass of the organic polymer component, for example.

(1-3) Other Components

In addition to the flame retardants, various additive agents, which can be generally added to the coating member of the cable, such as impact modifying agents, stabilizers, expanders, anti-aging agents, pigments, and lubricants, can be used as additive agents to be contained in the jacket 15. However, it is preferable that these additive agents substantially do not form chloride, or even when they form chloride, the amount of formed chloride is negligible. The total content of the additive agents other than the flame retardant is preferably not more than 30 parts by mass with respect to 100 parts by mass of the organic polymer component.

In particular, it is preferable that an antioxidant and/or an anti-aging agent is added to the jacket 15. Due to the addition of an antioxidant and/or anti-aging agent, the degradation and aging of the organic polymer component through oxidation tends not to progress even at high temperatures, and the heat resistance of the jacket 15 is increased. A hindered phenol-based antioxidant can be favorably used as an antioxidant. Zinc oxide and/or an imidazole-based compound can be favorably used as an anti-aging agent.

(2) Inner Layer of Communication Cable

The following describes the constituent component of the insulating covering 13 serving as the inner layer of the communication cable 1. The insulating covering 13 is made of a composition obtained by adding an additive agent to an organic polymer as appropriate.

There is no particular limitation to the type of organic polymers constituting the insulating covering 13. Similarly to the jacket 15, a preferable example of the composition of the insulating covering 13 is a composition containing an olefin-based polymer as the main component. An olefin-based polymer such as a polyolefin has a low permittivity, and provides excellent communication characteristics to the communication cable 1 by configuring the insulating covering 13 surrounding the outer circumferential surface of the conductor 12. Unlike the organic polymer component constituting the jacket 15, there is no particular limitation to the number of components and the elastic modulus of the organic polymer component constituting the insulating covering 13. Because multiple types of organic polymers need not be mixed, any one type of polyolefin can be used as the organic polymer component constituting the insulating covering 13, for example. However, similarly to the organic polymer component constituting the jacket 15, an organic polymer component containing two or more types of organic polymers having different elastic moduli may be used as the organic polymer component constituting the insulating covering 13. The organic polymer component may be crosslinked or foamed in the insulating covering 13.

As described above, if the communication cable 1 is provided with the outer layer such as the jacket 15 and the outer layer contains the chloride-forming flame retardant, the insulating covering 13 serving as the inner layer need not contain the chloride-forming flame retardant. However, similarly to the jacket 15, as a preferable embodiment, the insulating covering 13 also contains a flame retardant as an additive agent, and at least a part of the flame retardant may be a chloride-forming flame retardant. In particular, the insulating covering 13 also preferably contains a chloride-forming flame retardant and a brominated flame retardant. The same configurations as those mentioned for the jacket 15 can be used for a specific type of each flame retardant and a preferable range of the amount of each flame retardant. The same additive agents as those mentioned for the jacket 15 can also be used for additive agents other than the flame retardants.

Note that the insulating covering 13 directly covers the conductor 12, and the dielectric properties of the constituent material of the insulating covering 13 are more likely to influence the communication characteristics of the communication cable 1 than the jacket 15 disposed at a position away from the conductor 12. Therefore, the communication characteristics of the communication cable 1 can vary depending on the type and the amount of the flame retardant added to the insulating covering 13. Because the brominated flame retardant has a lower permittivity than magnesium hydroxide, for example, if part of magnesium hydroxide is replaced with the brominated flame retardant, the permittivity of the overall constituent material of the insulating covering 13 will decrease. The constituent material of the jacket 15 preferably has a low permittivity because the influence of electromagnetic noise on the jacket 15 tends to decrease when the constituent material of the jacket 15 has a low permittivity. However, a low permittivity of the constituent material of the insulating covering 13 tends to have a great influence on the characteristic impedance of the communication cable 1, and the characteristic impedance may not be within a predetermined range.

Specifically, as will be described in the following examples, when the permittivity of the insulating covering 13 decreases due to the addition of a brominated flame retardant, the characteristic impedance of the communication cable 1 increases. In order to suppress an increase in the characteristic impedance, the insulating covering 13 needs to be thin. A reduction in the thickness of the insulating covering 13 is also advantageous from the viewpoint of reducing the diameter of the insulated electric wire 11. If the cross-sectional area of the conductor of each insulated electric wire 11 is 0.1475 mm² and the content of magnesium hydroxide and the brominated flame retardant in the jacket 15 is in the above-mentioned preferable range, for example, then the communication cable 1 can have a characteristic impedance of 100±10Ω by setting the thickness of the corresponding insulating covering 13 to be smaller than 0.18 mm, for example, in a range of not more than 0.16 mm

(3) Chlorine-Containing Coating Layer of Parallel Cable

The following describes the constituent material of the chlorine-containing coating layer 22 of the parallel cable 2. The chlorine-containing coating layer 22 is made of a polymer composition containing an organic polymer and a plasticizer.

The polymer composition constituting the chlorine-containing coating layer 22 contains a component containing chlorine atoms. Although the component having chlorine atoms may be an organic polymer or an additive component (other than a plasticizer) to be added to the organic polymer, the chlorine atoms are preferably contained in the organic polymer. Examples of the organic polymer having chlorine atoms that can be used in the chlorine-containing coating layer 22 include polyvinyl chloride (PVC) and chlorinated polyethylene (CPE). Cables whose conductors are covered by a composition obtained by adding a plasticizer to PVC are widely used in the fields of automobiles and the like. The organic polymer may be crosslinked or foamed in the chlorine-containing coating layer 22.

Although there is no particular limitation to the type of plasticizer contained in the chlorine-containing coating layer 22, examples of plasticizers generally added for the purpose of softening PVC include phthalate-based plasticizers such as diisononyl phthalate (DINP) and dioctyl phthalate (DNOP), trimellitate-based plasticizers such as tris(2-ethylhexyl) trimellitate (TOTM), and polyester-based plasticizers. In these plasticizers, lower molecular weight plasticizers such as phthalate-based plasticizers and trimellitate-based plasticizers are more likely to be transferred to the material that is in contact with the plasticizers than polymer plasticizers, and the transfer suppression effect can be improved by providing the communication cable 1 with the jacket 15 having a predetermined material composition and a predetermined elastic modulus. The content of the plasticizer in the chlorine-containing coating layer 22 is preferably at least 10 parts by mass and not more than 50 parts by mass with respect to 100 parts by mass of the organic polymer component.

The chlorine-containing coating layer 22 may contain an additive agent other than the plasticizers as appropriate. It is possible to use, as such an additive agent, the same additive agents mentioned above that can be added to the jacket 15. The total content of the additive agents is preferably not more than 30 parts by mass with respect to 100 parts by mass of the organic polymer component.

Suppression of Transfer of Plasticizer and Chlorine Atoms by Outer Layer

In the communication cable 1, the organic polymer component has the above-described predetermined elastic modulus and component composition, and thus the jacket 15 serving as the outer layer can suppress the transfer of the plasticizer and chlorine atoms from the chlorine-containing member that is in contact with the jacket 15, such as the chlorine-containing coating layer 22 of the parallel cable 2, to the jacket 15 serving as the outer layer and the insulating covering 13 serving as the inner layer. The following describes the transfer of the plasticizer and chlorine atoms and the suppression of the transfer of the plasticizer and chlorine atoms.

The plasticizer contained in the chlorine-containing coating layer 22 of the parallel cable 2 may be transferred to the jacket 15 of the communication cable 1 that is in contact with the chlorine-containing coating layer 22 in high temperatures. When the plasticizer is transferred to the jacket 15, the plasticizer may diffuse into the layer of the jacket 15 and also be transferred to the insulating covering 13 of the signal wire 10. When the plasticizer diffuses in the structure of the polymer material, the path where chlorine atoms having an affinity with the plasticizer can diffuse is formed in a portion where the plasticizer has diffused. As a result, chlorine atoms contained in the chlorine-containing coating layer 22 can also be transferred to the polymer material together with the plasticizer. The transfer of chlorine atoms can be considered to proceed mainly in the form of chlorine-containing molecules such as hydrochloric acid molecules (HCl) and chlorine molecules (Cl₂), and in this specification, the transfer in the form of chlorine-containing molecules is also referred to as “the transfer of chlorine atoms”. Similarly to the plasticizer, chlorine atoms may pass through the layer of the jacket 15 and be transferred to the insulating covering 13 of the signal wire 10.

When chlorine atoms are transferred to the jacket 15 and further transferred to the insulating covering 13 accompanying the transfer of the plasticizer, these chlorine atoms may form chloride with the chloride-forming flame retardant contained in the jacket 15 and/or the insulating covering 13. If the chloride-forming flame retardant is magnesium hydroxide (Mg(OH)₂), for example, magnesium chloride (MgCl₂) may be formed through reaction with the transferred chlorine-containing molecules.

When chloride derived from the flame retardant is formed in the layers of the jacket 15 and/or the insulating covering 13, the formed chloride may influence the communication characteristics of the communication cable 1 due to changes in the dielectric properties of the materials constituting the layers, and the like. In particular, if the formed chloride is a deliquescent chloride, the chloride tends to greatly influence the communication characteristics. Magnesium chloride, which is a chloride formed from magnesium hydroxide, is a deliquescent chloride, for example. When a deliquescent chloride is formed, the chloride absorbs moisture in the air and forms hydrates, creating an atmosphere containing water droplets and water vapor in the layers of the jacket 15 and the insulating covering 13 or their surfaces, or in the space surrounded by these layers. Water droplets and water vapor change the dielectric properties of the materials, such as an increase in permittivity, and as a result, influence the communication characteristics of the communication cable 1. In particular, when water droplets are locally formed in the layers of the jacket 15 and/or the insulating covering 13 and in the space surrounded by these layers, the electromagnetic filed is locally distorted around the region where these water droplets are formed. As a result, the communication characteristics of the communication cable 1 tend to deteriorate. The formation of chloride derived from the flame retardant is more likely to greatly influence the communication characteristics in the insulating covering 13 that is in contact with the conductor 12 than in the jacket 15.

However, in the communication cable 1 according to this embodiment, the organic polymer component constituting the jacket 15 has a tensile modulus of at least 100 MPa, and contains two types of organic polymers having different tensile moduli. Therefore, the transfer of the plasticizer from the chlorine-containing coating layer 22 to the jacket 15 is suppressed. Because the transfer of the plasticizer is suppressed, the path along which chlorine-containing molecules can pass tends not to be formed in the structure of the organic polymer, and the transfer of chlorine atoms from the chlorine-containing coating layer 22 is also suppressed. When the transfer of the plasticizer and the subsequent transfer of chlorine atoms are suppressed in the jacket 15, the transfer of the plasticizer and chlorine atoms to the insulating covering 13 inward of the jacket 15 is also suppressed.

A high tensile modulus of the organic polymer material means that the material has a hard and dense structure, and the space through which foreign molecules such as a plasticizer can pass is small or the number of such spaces is small. Therefore, because the organic polymer component constituting the jacket 15 has an elastic modulus of at least the predetermined lower limit, such as at least 100 MPa, the plasticizer tends not to be transferred to the jacket 15 or further transferred to the insulating covering 13.

Further, in this embodiment, the organic polymer material constituting the jacket 15 contains the first organic polymer and the second organic polymer that have different tensile moduli. In this case, the first organic polymer has a lower elastic modulus than the second organic polymer. Thus, if the plasticizer enters the constituent material of the jacket 15, then the plasticizer is more likely to enter the structure constituted by the first organic polymer than the structure constituted by the second organic polymer. However, the continuity of the structure of the first organic polymer is divided by the structure of the second organic polymer due to the first organic polymer and the second organic polymer being mixed, and the plasticizer diffuses within the structure of the first organic polymer and reaches a predetermined depth, extending the path along which the plasticizer needs to pass. Therefore, the time the plasticizer takes to enter to reach the predetermined depth is longer when the second organic polymer is mixed in the organic polymer material than when only the organic polymer material is made of the first organic polymer, and the plasticizer tends not to enter. Also, as will be described in the later examples, because the first organic polymer and the second organic polymer are mixed in the organic polymer component, even when the overall organic polymer component has the same elastic modulus as an organic polymer component made of a single material, the plasticizer is less likely to enter than the organic polymer component made of the single material. In particular, if the first organic polymer and the second organic polymer are in a polymer alloy state, it is possible to effectively suppress the entry of the plasticizer.

As described above, the organic polymer component constituting the jacket 15 has an elastic modulus of at least 100 MPa and contains the first organic polymer and the second organic polymer that have different elastic moduli. Therefore, it is possible to effectively suppress the transfer of the plasticizer to the inside of the jacket 15 and the transfer of the plasticizer to the insulating covering 13 via the jacket 15. Suppression of the transfer of the plasticizer can effectively suppress the transfer of chlorine atoms, which is a phenomenon accompanying the transfer of the plasticizer. When the transfer of chlorine atoms to the jacket 15 and the insulating covering 13 is suppressed, the transferred chlorine atoms tend not to react with the chloride-forming flame retardant to form chloride and not to influence the communication characteristics of the communication cable 1. In particular, if the insulating covering 13 that is in contact with the conductor 12 contains the chloride-forming flame retardant, when chloride is formed accompanying the transfer of chlorine atoms, the communication characteristics of the communication cable 1 tend to be greatly influenced. However, the jacket 15 can effectively suppress the transfer of chlorine atoms to the insulating covering 13 and reduce the influence on the communication characteristics of the communication cable 1.

The transfer of the plasticizer and the subsequent transfer of chlorine atoms tend to occur in a high-temperature environment. However, the jacket 15 suppresses the transfer of the plasticizer and chlorine atoms, and thus the communication cable 1 and the wire harness 3 can be used with high reliability even in a high-temperature environment such as the vicinity of the engine in an automobile. It is possible to effectively suppress the chloride formation in the jacket 15 and the insulating covering 13 and reduce the influence on communication characteristics even in an environment at a temperature of at least 80° C., or at least 100° C., for example. Note that a “high temperature” in an automobile means a temperature of about 120° C. as the highest temperature, and the transfer of the plasticizer and the subsequent transfer of chlorine atoms at even higher temperatures do not raise any issues as long as the communication cable 1 and the wire harness 3 are not used for automobiles at a temperature of higher than 120° C. Further, as described above, if a brominated flame retardant is used in combination with the chloride-forming flame retardant as the flame retardants, the durability of the organic polymer component can be improved even in a high-temperature environment, and the communication cable 1 and the wire harness 3 are suitable for use in an environment where the temperature can be high.

### Examples

The following describes examples. Note that the present invention is not limited to these examples. In this examples, characteristics are evaluated at room temperature in the atmosphere.

(1) Change Accompanying Transfer of Chlorine Atoms

First, it was examined how the components and communication characteristics of the communication cable changed accompanying the transfer of the plasticizer and chlorine atoms.

Production of Samples

A cable conductor having a cross-sectional area of 0.1475 mm² was produced by twisting seven copper alloy wires with a diameter of 00.172 mm. A material containing the following components was extruded on the outer circumferential surface of the obtained cable conductor to form an insulating covering having a thickness of 0.16 mm. A signal wire was produced by twisting two insulated electric wires obtained in this manner at a pitch of 20 mm. Further, a hollow jacket with a thickness of 0.47 mm was formed by extruding a material containing the following components on the outer circumferential surface of the signal wire, and a communication cable was produced.

The materials used to form the insulating covering of the signal wire and the jacket were prepared by kneading the following components. Two types of samples were prepared. In one type of samples, magnesium hydroxide and a brominated flame retardant were used as flame retardants added to the insulating covering and the jacket. In the other type of samples, only magnesium hydroxide was used. Samples in which magnesium hydroxide and the brominated flame retardant were used as flame retardants had the composition stated below. With regard to the samples in which only magnesium hydroxide was used as a flame retardant, the total amount of the brominated flame retardant having the following composition was replaced with magnesium hydroxide for both the insulating covering and the jacket. However, antimony trioxide was not added.

### Insulating Covering

Organic Polymer Component:

37.5 parts by mass of “NOVATECH EC9GD” (polypropylene manufactured by Japan Polypropylene Corporation; tensile modulus was 1189 MPa)

37.5 parts by mass of “NOVATECH FY6H” (polypropylene manufactured by Japan Polypropylene Corporation; tensile modulus was 1800 MPa)

12.5 parts by mass of “Prime Polypro E701G” (polypropylene manufactured by Prime Polymer Co., Ltd. and having a tensile modulus of 1250 MPa)

12.5 parts by mass of “Tuftec M1913” (SEBS manufactured by Asahi Kasei Corp.)

Flame Retardant:

30 parts by mass of magnesium hydroxide (“KISUMA 5” manufactured by Kyowa Chemical Industry Co., Ltd.)

20 parts by mass of brominated flame retardant (ethylene bis(pentabromophenyl) “SAYTEX8010” manufactured by Albemarle Corporation)

Other Additive Agents:

10 parts by mass of antimony trioxide (manufactured by Yamanaka & Co., Ltd.)

5 parts by mass of zinc oxide (“zinc oxide #2” manufactured by HAKUSUI TECH)

5 parts by mass of imidazole-based compound (2-mercaptoimidazole “ANTAGE MB” manufactured by Kawaguchi Chemical Industry Co., Ltd.)

3 parts by mass of antioxidant (hindered phenol-based antioxidant “IRGANOX 1010” manufactured by BASF)

0.5 parts by mass of metal deactivator (“CDA-1” manufactured by ADEKA Corporation)

Jacket—specific product is the same as the above insulating covering, unless otherwise stated.

Organic Polymer Component:

25 parts by mass of “NOVATECH EC9GD” (tensile modulus was 1189 MPa)

30 parts by mass of “Santprene 203-40” (polyolefin elastomer manufactured by Exxon Mobil; flexural modulus was 80 MPa)

20 parts by mass of “Adfex Q200F” (polyolefin elastomer manufactured by Lyondel Basell; tensile modulus was 155 MPa)

12.5 parts by mass of “Prime Polypro E701G” (tensile modulus was 1250 MPa)

12.5 parts by mass of “Tuftec M1913”

Flame Retardant:

40 parts by mass of magnesium hydroxide

30 parts by mass of brominated flame retardant

Other Additive Agents:

15 parts by mass of antimony trioxide

5 parts by mass of zinc oxide

5 parts by mass of imidazole-based compound

3 parts by mass of antioxidant

Further, a chlorine-containing coating layer was formed on the outer circumferential surface of the cable conductor that was the same as the above, forming a parallel cable. Used was a chlorine-containing coating layer obtained by adding, as a plasticizer, 20 parts by mass of tri-n-alkyl trimellitate (“TRIMEX N-08” manufactured by Kao Corporation) to 100 parts by mass of vinyl chloride.

Evaluation Methods

An assembly in which the communication cable and the parallel cable formed above were in contact with each other was kept heated to a predetermined temperature for a predetermined period of time. The heating temperature was set in a range of 110° C. to 150° C. in increments of 10° C.

The assembly, which had been kept at the predetermined temperature for the predetermined period of time, was allowed to cool to room temperature, and the characteristic impedance of the communication cable was then measured in the differential mode. The characteristic impedance was measured using the open/short method using an LCR meter.

Further, the jacket was removed from the heated signal communication cable, and the products in the jacket were analyzed. The analysis was performed on the jacket, which had been frozen and crushed, through gas chromatography. Also, as a representative sample (heated at 150° C. for 120 hours when only magnesium hydroxide was used as a flame retardant), a cross-section of the communication cable was observed using a scanning electron microscope (SEM).

Results

According to the results obtained by analyzing the product in the jacket for the heated communication cable, when only magnesium hydroxide was used as a flame retardant, magnesium chloride (MgCl₂) was detected when the heating temperature was at least 130° C. Also, as a result of the SEM observation, a structure associated with minute water droplets was observed in the layer and the surface of the jacket and the space surrounded by the jacket. Based on this, it was revealed that as a result of heating the jacked at a high temperature while the parallel cable having the chlorine-containing coating layer was in contact with the communication cable, magnesium chloride was produced, and water was produced in the layer and the surface of the jacket and in the space surrounded by the jacket accompanying the production of magnesium chloride. It is understood that these phenomena result from the fact that the plasticizer was transferred from the chlorine-containing coating layer to the jacket due to the jacket being heated in contact with the chlorine-containing coating layer, and chlorine atoms were also transferred from the chlorine-containing coating layer to the jacket accompanying the transfer of the plasticizer, leading to the reaction with magnesium hydroxide contained in the jacket as the flame retardant. It seems that the magnesium chloride produced through the reaction is a deliquescent chloride, and water droplets were formed by absorbing moisture in the form of hydrates from the air.

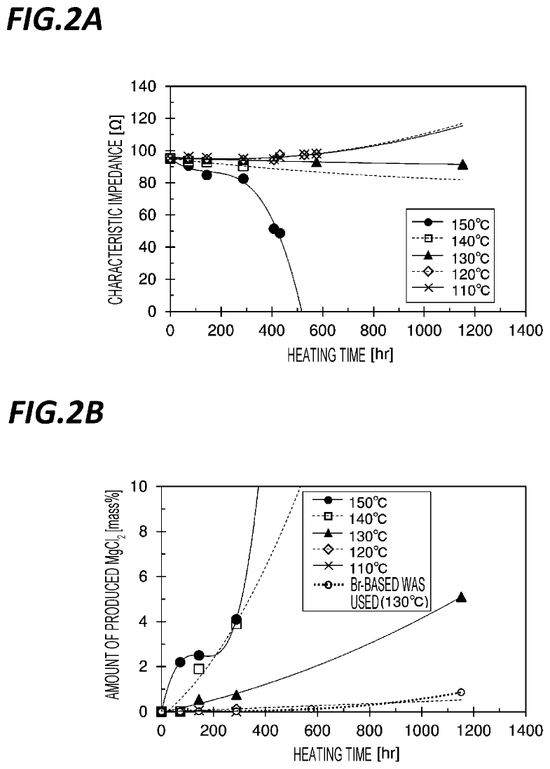

FIGS. 2A and 2B show the changes in the characteristic impedance and the amount of magnesium chloride produced over the heating time when the samples in which only magnesium hydroxide was used as the flame retardant were heated at the set temperatures. In FIG. 2A, the heating time is shown on the horizontal axis, and the characteristic impedance is shown on the vertical axis (the unit: SI). In FIG. 2B, the heating time is shown on the horizontal axis, and the amount of magnesium chloride produced is shown on the vertical axis (the unit: mass %). As for any measurement values, approximate curves obtained through approximation of data points using a smooth polynomial are also shown in these drawings together with the data points.

First, according to FIG. 2B, when the heating temperature was 110° C., a detectable amount of magnesium chloride was not formed. Even when the heating temperature was 120° C., only a small amount of chloride was produced. On the other hand, when the heating temperature was at least 130° C., a large amount of magnesium chloride was produced. The amount of produced magnesium chloride increased as the heating temperature increased and the heating time extended. Note that, as described above, “high temperature” in an automobile refers to a temperature of about 120° C. at the highest. If an insulated electric wire is used for an automobile, it is sufficient that chloride production at a heating temperature of 120° C. can be suppressed.

Next, according to the measured characteristic impedance shown in FIG. 2A, if at least the heating time was within 500 hours under the conditions of 110° C. and 120° C. where magnesium chloride was not (almost) produced in the above, the characteristic impedance did not change much from the initial value (about 95Ω). When the heating time was longer than about 500 hours, the characteristic impedance increased slowly. On the other hand, when the heating temperature was at least 130° C., the characteristic impedance decreased as the heating proceeded. The characteristic impedance decreased more rapidly as the heating temperature increased. Also, the shape of the curve of a decrease in the characteristic impedance substantially corresponded to the shape of the curve of an increase in the amount of produced magnesium chloride. The faster the magnesium chloride production rate was, the more rapidly the characteristic impedance decreased.

There was a high correlation between the production of magnesium chloride and a decrease in the characteristic impedance in this manner, and it was found that the production of magnesium chloride causes a decrease in the characteristic impedance. As described above, when magnesium chloride is produced by the transfer of chlorine atoms accompanying the transfer of the plasticizer at high temperatures and hydrates are formed, the permittivity of the jacket and the effective permittivity of the space surrounded by the jacket in the communication cable increase. As a result, it is understood that the characteristic impedance of the communication cable decreases.

Although the samples were described above in which only magnesium hydroxide was used as the flame retardant, the samples in which magnesium hydroxide and the brominated flame retardant were used as the flame retardants were also heated to 130° C. in the same manner, and the amount of produced magnesium chloride was evaluated. The results therefor are also shown in FIG. 2(b) (Br-based was used (130° C.)). Based on this, the amount of produced magnesium chloride was significantly reduced by using the brominated flame retardant in combination with magnesium hydroxide, compared to the samples in which only magnesium hydroxide was used and heated at the same temperature of 130° C. This is because the use of the brominated flame retardant in combination with magnesium hydroxide makes magnesium hydroxide tend not to lead to secondary aggregation, lowering the rate of the production of magnesium chloride through the reaction with chlorine atoms.

(2) Composition of Organic Polymer Component and Transfer of Plasticizer

Next, the relationship between the tensile modulus and the composition of the organic polymer component and the transfer of the plasticizer was examined.

Production of Samples

Samples A1 to A7 were each prepared by using one type of olefin-based polymers below or kneading two types of olefin-based polymers below in the blend amount (the unit: mass %) shown in Table 1 and molding the resultant polymer to a sheet member.

Olefin-Based Polymers Used

“Adflex Q100F”: polyolefin elastomer manufactured by Lyondel Basell; tensile modulus was 113 MPa

“Adflex Q200F”: polyolefin elastomer manufactured by Lyondel Basell; tensile modulus was 155 MPa

“Adflex Q300F”: polyolefin elastomer manufactured by Lyondel Basell; tensile modulus was 349 MPa

“TAFMER XM-7080”: polyolefin elastomer manufactured by Mitsui Chemicals, Inc.; tensile modulus was 394 MPa

“NOVATECH EC9GD”: polypropylene manufactured by Japan Polypropylene Corporation; tensile modulus was 1189 MPa

“Newcon NAR6”: polyolefin elastomer manufactured by Japan Polypropylene Corporation; tensile modulus was 574 MPa

“NOVATECH FL6510G”: polypropylene manufactured by Japan Polypropylene Corporation; tensile modulus was 2760 MPa

Evaluation Method

The tensile modulus was evaluated by performing tensile testing on the sheet members formed above in conformity to JIS K 7161-1: 2014. Note that the above-mentioned tensile modulus values for the olefin-based polymers used as raw materials were also obtained through actual measurements performed in the same manner (the same applies to the test (1)).

The mass of the sheet members produced above were measured, immersed in a plasticizer solution (TRIMEX N-08) heated to 120° C., and left at 120° C. for 4 hours. Then, an excess plasticizer was removed from the surface of each sheet member taken out from the plasticizer solution, and the mass of the sheet member was then measured. For each sheet member, the plasticizer absorption ratio of each material was calculated using (M1−M0)/M0×100% where the mass of the sheet member before immersion in the plasticizer was M0 and the mass of the sheet member after immersion in the plasticizer was M1.

Results

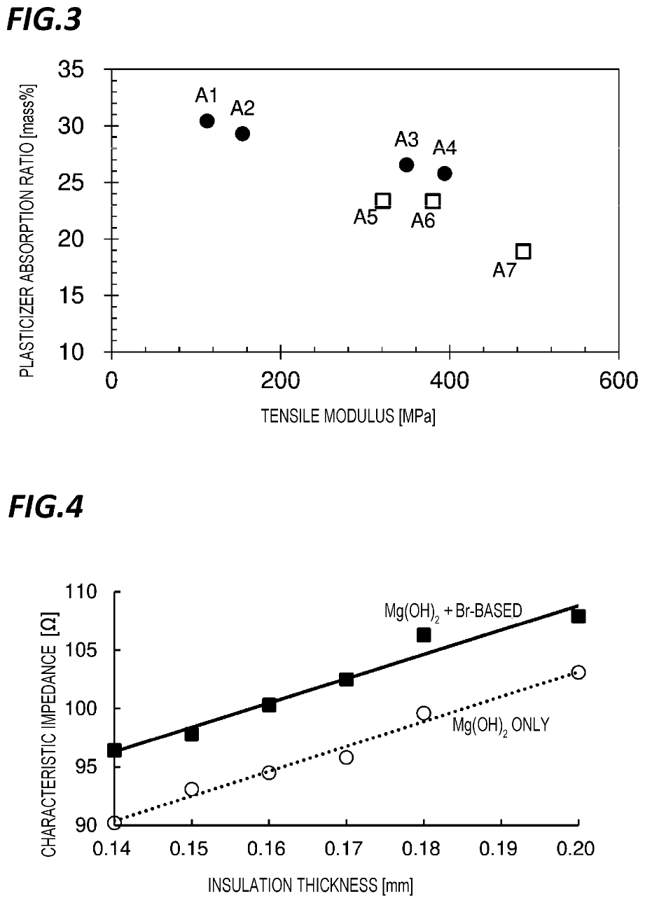

Table 1 shows the component compositions of the sheet members of the samples A1 to A7 and the results of measurements of the tensile modulus and plasticizer absorption ratios thereof. Also, FIG. 3 shows the relationship between the tensile modulus and the plasticizer absorption ratio. The plasticizer absorption ratio is shown on the horizontal axis, and the tensile modulus is shown on the vertical axis. The samples (samples A1 to A4) in which only one type of olefin-based polymer was used are indicated by black circles, and the samples (samples A5 to A7) in which two or more types of olefin-based polymers were mixed are indicated by white squares. Sample numbers are also shown in FIG. 3 in correspondence with the data points.

TABLE 1

| Raw Materials | | | | | | | | |
|---|---|---|---|---|---|---|---|---|
| | Elastic | | | | | | | |
| | Modulus | Sample Number | | | | | | |
| Name | [MPa] | A1 | A2 | A3 | A4 | A5 | A6 | A7 |
| Adflex Q100F (elastomer) | 113 | 100 | 0 | 0 | 0 | 80 | 0 | 0 |
| Adflex Q200F (elastomer) | 155 | 0 | 100 | 0 | 0 | 0 | 80 | 80 |
| Adflex Q300F (elastomer) | 349 | 0 | 0 | 100 | 0 | 0 | 0 | 0 |
| TAFMER XM-7080 (elastomer) | 394 | 0 | 0 | 0 | 100 | 0 | 0 | 0 |
| NOVATECH EC9GD (PP) | 1189 | 0 | 0 | 0 | 0 | 0 | 0 | 20 |
| Newcon NAR6 (elastomer) | 574 | 0 | 0 | 0 | 0 | 0 | 20 | 0 |
| NOVATECH FL6510G (PP) | 2760 | 0 | 0 | 0 | 0 | 20 | 0 | 0 |

| | | | | | | | |
|---|---|---|---|---|---|---|---|
| Overall Tensile Modulus [MPa] | 113 | 155 | 349 | 394 | 321 | 380 | 487 |
| Plasticizer Absorption Ratio [mass %] | 30.4 | 29.3 | 26.5 | 25.8 | 23.4 | 23.3 | 18.9 |

According to Table 1, two types of olefin-based polymers were mixed in the samples A5 to A7, and thus these samples each had a tensile modulus between the tensile moduli of these two types of olefin-based polymers as a whole material. Based on this, it was confirmed that the tensile modulus of the overall material can be adjusted by selecting the elastic moduli of the two types of organic polymers to be mixed and the mixing ratio of these organic polymers as appropriate.

According to FIG. 3, as for the samples (samples A1 to A4) in which only one type of organic polymer was used and the samples (samples A5 to A7) in which two types of organic polymers were mixed, there is a tendency that the higher the tensile modulus of a material is, the lower the plasticizer absorption ratio is. It is understood that this tendency results from the fact that, when the organic polymer material has a high tensile modulus and the material has a dense structure, the plasticizer tends not to enter the material. Also, it is conceivable that, when the organic polymer material was brought into contact with the material containing the plasticizer and chlorine atoms, such as the chlorine-containing coating layer in the above test (1), a sample with a higher tensile modulus with less plasticizer transfer has less chlorine atom transfer accompanying the plasticizer transfer.

Further, according to FIG. 3, it was found that the samples A5 to A7 in which two types of organic polymers were used have a lower plasticizer absorption ratio overall, compared with the samples A1 to A4 in which only one type of organic polymers is used. When the plasticizer absorption ratios of the samples A3 and A5 having close tensile moduli are compared with each other and the plasticizer absorption ratios of the samples A4 and A6 are also compared with each other, for example, the samples A5 and A6 had a significantly lower plasticizer absorption ratio than the samples A3 and A4. That is, the transfer of the plasticizer can be further suppressed by mixing two types of organic polymers having different tensile moduli, than when only one type of organic polymer is used. It is inferred that this result is obtained because the path along which the plasticizer needs to pass to reach the inside of the material is extended by forming a structure in which minute material structures are mixed by mixing two types of organic polymers together.

(3) Composition of Flame Retardant and Properties of Materials

Next, the composition of a flame retardant added to the organic polymer material, and the relationship between the flame-retardancy and the heat resistance of the material were examined.

Production of Samples

Samples B1 to B7 were prepared by kneading materials shown in Table 2 below in mass ratios shown in Table 2 and molding the resultant material into a sheet member. At this time, the components labeled as “anti-aging masterbatch” were independently well mixed in advance, and then kneaded with other components. The used components will be described below in detail.

Base Resin

PP1: polypropylene “NOVATECH EC9GD” manufactured by Japan Polypropylene Corporation; tensile modulus was 1189 MPa

Elastomer 1: polyolefin elastomer “Adflex Q200F” manufactured by Lyondel Basell; tensile modulus was 155 MPa

Elastomer 2: polyolefin elastomer “Santoprene 203-40” manufactured by Exxon Mobil; flexural modulus was 80 MPa

SEBS: “Tuftec M1913” manufactured by Asahi Kasei Corp.

### Anti-Aging Masterbatch

PP2: polypropylene “Prime Polypro E701G” manufactured by Prime Polymer Co., Ltd.

SEBS: “Tuftec M1913” manufactured by Asahi Kasei Corp.

Zinc oxide: “zinc oxide #2” manufactured by HAKUSUI TECH

Imidazole-based compound: 2-mercaptoimidazole “ANTAGE MB” manufactured by Kawaguchi Chemical Industry Co., Ltd.

### Flame Retardant

Magnesium hydroxide: “KISUMA 5” manufactured by Kyowa Chemical Industry Co., Ltd.

Brominated flame retardant: ethylene bis(pentabromophenyl) “SAYTEX 8010” manufactured by Albemarle Corporation

Antimony trioxide: manufactured by Yamanaka & Co., Ltd.

### Other Additive Agents

Antioxidant: hindered phenol-based antioxidant “Irganox 1010FF” manufactured by BASF

Evaluation Method

The flame-retardancy and heat resistance of the samples B1 to B7 obtained above were evaluated.

The flame-retardancy was evaluated using a fire test. The flame-retardancy was evaluated based on the time taken from burning to the flame out with reference to standards ISO 6722-1(2011) for the test methods and test conditions. In the test, when the flame was extinguished within 70 seconds and the fire was extinguished well, the sample was evaluated as being “A” with high flame-retardancy. On the other hand, when the flame did not go out within 70 seconds and burning continued, the sample was evaluated as being “B” with low flame-retardancy.

The heat resistance was evaluated using a heat resistance service life test. In the same manner as in the above test (1), a wire harness was produced as an assembly sample in which the parallel cable having the chlorine-containing coating layer was in contact with the communication cable provided with the jacket on the outer circumferential surface of the signal wire configured as a twisted wire pair. At this time, the wire harness was formed by producing seven types of communication cables using any one type of compositions of the samples B1 to B7 for the insulating covering of the signal wire and the jacket and bringing the parallel cable into contact with the corresponding communication cable.

The test methods and test conditions conformed to the heat resistance test 2 in JASO D618 6.9. The sample in the form of the wire harness produced above was heated at predetermined temperature for a predetermined period of time (100° C.×10,000 hours). Then, the communication cable was removed from the wire harness, a sample of the communication cable having the jacket and a sample of the signal wire from which the jacket was removed were wound around the mandrel with its diameter. If the conductor was not exposed, a withstand voltage test was performed. If the conductor was not exposed even in the withstand voltage test, then tensile testing was further carried out. If the conductor was not exposed from the communication cable sample or the signal wire sample in the winding test and the withstand voltage test, then the samples were evaluated as being “A” with high heat resistance. In particular, if the elongation rate measured in the tensile testing was at least ⅓ of the initial value, the samples had a favorable service life and thus were evaluated as being “A+” with particularly high heat resistance. On the other hand, if the conductor was exposed from at least one of the communication cable sample and the signal wire sample in the winding test or the withstand voltage test, then the samples were evaluated as being “B” with low heat resistance,

Results of Evaluation

The component compositions of the materials of the samples B1 to B7 obtained above, and the results of the evaluations of the flame-retardancy and heat resistance are outlined in Table 2. In Table 2, as for the component composition, the content of each component is listed in units of parts by mass. The total amount of the overall organic polymer component, that is, the four constituent components of the base resin and two types of organic polymer components contained in an anti-aging masterbatch, was set to 100 parts by mass. Samples B1 to B7 are different from each other in the content of their components classified as flame retardants. Table 2 has two columns for the sample B2 with the same content for making comparison easier.

TABLE 2

| | | Sample Number | | | | | | | |
|---|---|---|---|---|---|---|---|---|---|
| Raw Materials | | B1 | B2 | B3 | B4 | B5 | B2 | B6 | B7 |
| Base Resin | PP1 | 22.5 | 22.5 | 22.5 | 22.5 | 22.5 | 22.5 | 22.5 | 22.5 |
| | Elastomer 1 | 22.5 | 22.5 | 22.5 | 22.5 | 22.5 | 22.5 | 22.5 | 22.5 |
| | Elastomer 2 | 30 | 30 | 30 | 30 | 30 | 30 | 30 | 30 |
| | SEBS | 5 | 5 | 5 | 5 | 5 | 5 | 5 | 5 |
| Anti-aging | PP2 | 12.5 | 12.5 | 12.5 | 12.5 | 12.5 | 12.5 | 12.5 | 12.5 |
| Masterbatch | SEBS | 7.5 | 7.5 | 7.5 | 7.5 | 7.5 | 7.5 | 7.5 | 7.5 |
| | Zinc Oxide | 5 | 5 | 5 | 5 | 5 | 5 | 5 | 5 |
| | Imidazole-based | 5 | 5 | 5 | 5 | 5 | 5 | 5 | 5 |
| | Compound | | | | | | | | |
| Flame | Magnesium | 20 | 40 | 60 | 80 | 40 | 40 | 40 | 40 |
| Retardant | Hydroxide | | | | | | | | |
| | Brominated flame | 30 | 30 | 30 | 30 | 10 | 30 | 50 | 70 |
| | retardant | | | | | | | | |
| | Antimony trioxide | 15 | 15 | 15 | 15 | 5 | 15 | 25 | 35 |
| Other Additive | Antioxidant | 3 | 3 | 3 | 3 | 3 | 3 | 3 | 3 |
| Agents | | | | | | | | | |

| | | | | | | | | |
|---|---|---|---|---|---|---|---|---|
| Total | 178 | 198 | 218 | 238 | 168 | 198 | 228 | 258 |
| Flame-retardancy | B | A | A | A | B | A | A | A |
| Heat Resistance | A+ | A+ | A | B | A+ | A+ | A | B |

In Table 2, the samples B1 to B4 are different from each other in the content of magnesium hydroxide out of the flame retardants. The sample B1 containing magnesium hydroxide in an amount of less than 30 parts by mass had low flame-retardancy, whereas the samples B2 to B4 containing magnesium hydroxide in an amount of at least 30 parts by mass had high flame-retardancy. On the other hand, the sample B4 containing magnesium hydroxide in an amount of not more than 70 parts by mass had low heat resistance, whereas the samples B1 to B3 containing magnesium hydroxide in an amount of not more than 70 parts by mass had high heat resistance. In particular, the samples B1 and B2 containing magnesium hydroxide in an amount of not more than 50 parts by mass had excellent heat resistance.

The samples B5, B2, B6, and B7 listed on the right side in Table 2 are different from each other in the content of the brominated flame retardant out of the flame retardants. The sample B5 containing a brominated flame retardant in an amount of less than 20 parts by mass has low flame-retardancy, whereas the samples B2, B6, and B7 containing a brominated flame retardant in an amount of at least 20 parts by mass had high flame-retardancy. On the other hand, the sample B7 containing a brominated flame retardant in an amount of more than 60 parts by mass had low heat resistance, whereas the samples B5, B2, and B6 containing a brominated flame retardant in an amount of not more than 60 parts by mass had high heat resistance. In particular, the samples B5 and B2 containing a brominated flame retardant in an amount of not more than 40 parts by mass had excellent heat resistance.

Based on the above, it is found that high flame-retardancy and high heat resistance can be achieved by using, as flame retardants, magnesium hydroxide in an amount of 30 parts by mass to 70 parts by mass and a brominated flame retardant in an amount of 20 parts by mass to 60 parts by mass in combination, with respect to 100 parts by mass of the organic polymer component in the layer of the polymer composition constituting the communication cable. In particular, when the magnesium hydroxide content is not more than 50 parts by mass and the brominated flame retardant content is not more than 40 parts by mass, particularly high flame-retardancy can be obtained.

(4) Composition of Flame Retardant and Thickness of Insulating Covering

Lastly, studies have been conducted to examine how the thickness of the insulating covering specified to obtain a predetermined characteristic impedance changes when the composition of the flame retardants contained in the insulating covering of the communication cable was changed.

Production of Samples

A cable conductor having a cross-sectional area of 0.1475 mm² was produced by twisting seven copper alloy wires with a diameter of 00.172 mm. An insulating covering was formed by extruding the same material as that used for forming the insulating covering in the above test (1) on the outer circumferential surface of the obtained cable conductor. A signal wire was produced by twisting two insulated electric wires obtained in this manner at a pitch of 20 mm. Further, a hollow jacket with a thickness of 0.47 mm was formed by extruding a material of the sample B2 produced in the above test (3) on the outer circumferential surface of the signal wire, and a communication cable was produced. At this time, a plurality of samples provided with insulating coverings with different thicknesses were produced.

Further, an insulating covering was formed using a material that does not contain a brominated flame retardant and contains only magnesium hydroxide as a flame retardant in an amount of 150 parts by mass with respect to 100 parts by mass of the organic polymer component, and then a similar communication cable was produced for comparison. The types and contents of the organic polymer component and additive agents other than the flame retardant that constituted the insulating covering, and the size of each part, and the like were the same as in the above samples in which magnesium hydroxide and a brominated flame retardant were used in combination as flame retardants. However, antimony trioxide was not added.

Evaluation Method

For the samples produced above whose insulating coverings had different thicknesses when magnesium hydroxide and the brominated flame retardant were contained as flame retardants and when only magnesium hydroxide was contained, the characteristic impedance of the samples was measured in the differential mode. The characteristic impedance was measured using the open/short method using an LCR meter.

Results

FIG. 4 shows the relationship between the thickness of the insulating covering and the characteristic impedance as for when magnesium hydroxide and the brominated flame retardant were contained as flame retardants (Mg(OH)₂+Br-based) and when only magnesium hydroxide is contained (only Mg(OH)₂). The thickness of the insulating covering is shown on the horizontal axis, and the characteristic impedance is shown on the vertical axis.

According to FIG. 4, when two flame retardants were used, the larger the thickness of the insulating covering was, the higher the characteristic impedance was. Also, when the insulating coverings had the same thickness, the use of magnesium hydroxide and the brominated flame retardant in combination as flame retardants makes the characteristic impedance higher than that of the samples in which only magnesium hydroxide was used. These results are associated with that fact that the brominated flame retardant had a lower permittivity than magnesium hydroxide.

This means that, as a result of using magnesium hydroxide and a brominated flame retardant in combination, a predetermined higher level of characteristic impedance can be obtained even when a thin insulating covering is formed, compared to the characteristic impedance obtained when using only magnesium hydroxide as a flame retardant. According to FIG. 4, in order to achieve a characteristic impedance of 100Ω, the thickness of the insulating covering needs to be 0.18 mm when only magnesium hydroxide is used as a flame retardant, whereas it is sufficient that the thickness of the insulating covering is 0.16 mm when magnesium hydroxide and a brominated flame retardant are used in combination. A desired characteristic impedance can be obtained by setting the thickness of the insulating covering as appropriate according to the blend of flame retardants in this manner.

Although the embodiments of this disclosure were described in detail above, the present invention is not limited to the above embodiments, and various modifications can be made without departing from the gist of the present invention.

### LIST OF REFERENCE NUMERALS

1 Communication cable
10 Signal wire
11 Insulated electric wire
12 Conductor
13 Insulating covering (inner layer)
15 Jacket (outer layer)
2 Parallel cable
21 Conductor
22 Chlorine-containing coating layer
3 Wire harness

1. A communication cable comprising:
a conductor for transmitting electric signals; and
an outer layer that is disposed outside the conductor and contains an organic polymer,
wherein the communication cable has:
at least one of a first form in which the outer layer contains a chloride-forming flame retardant capable of forming a chloride and
a second form in which an inner layer, which contains an organic polymer and a chloride-forming flame retardant capable of forming a chloride, is further provided between the outer layer and the conductor,
the outer layer contains a first organic polymer and a second organic polymer having a higher tensile modulus than the first organic polymer, and
the overall organic polymer component constituting the outer layer has a tensile modulus of at least 100 MPa.

2. The communication cable according to claim 1,
wherein the overall organic polymer component constituting the outer layer has a tensile modulus of at least 300 MPa.

3. The communication cable according to claim 1,
wherein the overall organic polymer component constituting the outer layer has a tensile modulus of not more than 500 MPa.

4. The communication cable according to claim 1,
wherein a chloride formed by the chloride-forming flame retardant is deliquescent chloride.

5. The communication cable according to claim 1,
wherein the chloride-forming flame retardant contains magnesium hydroxide.

6. The communication cable according to claim 1,
wherein the first organic polymer and the second organic polymer are each independently a polyolefin or an olefin-based elastomer.

7. The communication cable according to claim 1,
wherein the communication cable has both the first form and the second form,
the outer layer contains the chloride-forming flame retardant, and
the inner layer containing the chloride-forming flame retardant is provided between the outer layer and the conductor.

8. The communication cable according to claim 1,
wherein the communication cable has a pair of insulated electric wires as signal wires each provided with an insulating covering as the inner layer on an outer circumferential surface of the conductor, and the outer layer covers an outer circumferential surface of the signal wire.

9. The communication cable according to claim 1,
wherein the outer layer in the first form and the inner layer in the second form contain the chloride-forming flame retardant and a brominated flame retardant.

10. The communication cable according to claim 9,
wherein the outer layer in the first form and the inner layer in the second form contain magnesium hydroxide serving as the chloride-forming flame retardant in an amount of 30 parts by mass to 70 parts by mass, and the brominated flame retardant in an amount of 20 parts by mass to 60 parts by mass with respect to 100 parts by mass of the organic polymer component.

11. The communication cable according to claim 8,
wherein the communication cable has at least the second form,
the insulating covering contains the brominated flame retardant as well as magnesium hydroxide serving as the chloride-forming flame retardant,
the thickness of the insulating covering is smaller than 0.18 mm, and
the characteristic impedance of the communication cable is 100±10 a

12. A wire harness comprising:
the communication cable according to claim 1; and
a chlorine-containing member made of a polymer composition containing a component having chlorine atoms and a plasticizer,
wherein the chloride-containing member is disposed in contact with at least a portion of the outer layer of the communication cable.

13. The wire harness according to claim 12,
wherein the chlorine-containing member is a coating member constituting a covered electric wire other than the communication cable.
